(19) United States
(12) Patent Application Publication
(10) Pub. No.: US 2026/0327370 A1
(43) Pub. Date: Oct. 22, 2026

(54) HALOGENATED OLEFIN-CONTAINING POLYURETHANE FOAM-FORMING COMPOSITIONS, RELATED FOAMS AND METHODS FOR THEIR PRODUCTION

(71) Applicant: Covestro LLC, Pittsburgh, PA (US)

(72) Inventors: Brandon W. Parks, McKees Rocks, PA (US); Rick L. Adkins, Hurricane, WV (US)

(21) Appl. No.: 19/485,384

(22) PCT Filed: Feb. 16, 2024
(86) PCT No.: PCT/US2024/016141

§ 371 Date: Nov. 18, 2025

Related U.S. Application Data
(60) Provisional application No. 63/508,557, filed on Jun. 16, 2023.

(51) Int. Cl. C08G 18/48; C08G 18/76; C08G 101/00; C08K 5/02

(52) U.S. Cl. CPC C08G 18/48; C08G 18/7657; C08K 5/02; C08G 2101/00; C08G 2110/0025

(57) ABSTRACT

Polyurethane foam-forming compositions include a polyol blend, a blowing agent composition, and a polyisocyanate. The polyol blend has a weighted average functionality of 3 to 6 and a weighted average hydroxyl number of 300 to 500 mg KOH/g. The blowing agent composition includes a physical blowing agent and a carbon dioxide-generating chemical blowing agent, in which the physical blowing agent includes a halogenated olefin that is present (i) in an amount of 1% to 30% by weight, based on total weight of the polyurethane foam-forming composition except for the weight of the polyisocyanate, and (ii) in an amount of at least 80% by weight, based on total weight of physical blowing agent in the blowing agent composition. The physical blowing agent composition and the carbon dioxide generating chemical blowing agent are present in a relative ratio, by weight, of at least 5:1. The polyisocyanate comprises a urethane-modified polyisocyanate having a NCO group content of 25 to 35% by weight, based on the total weight of the urethane-modified polyisocyanate, and includes a reaction product of components comprising a polymethylene polyphenyl polyisocyanate and a monol.

### FIELD

This specification pertains generally to halogenated olefin-containing polyurethane foam-forming compositions, and polyurethane foams produced therefrom.

### BACKGROUND

Rigid polyurethane foams are used in numerous applications. They are produced by reacting a polyisocyanate and an isocyanate-reactive compound, usually a polyol, in the presence of a blowing agent. One use of such foams is as a thermal insulation medium in the construction of refrigerated storage devices, including refrigerated appliances and tractor trailers. The thermal insulating properties of closed-cell rigid foams are dependent upon a number of factors, including the average cell size and the thermal conductivity of the contents of the cells.

The thermal conductivity of the contents of the cells depends upon the blowing agent(s) used. Fluorocarbons have historically often been used because of their low thermal conductivity. However, fluorocarbons, including chlorofluorocarbons (“CFCs”), hydrofluorocarbons (“HFCs”) and hydrochlorofluorocarbons (“HCFCs”), are greenhouse gases that have been phased out of use. Halogenated olefins, such as HCFOs, are environmentally-friendlier alternatives for such fluorocarbons, but they can be costly.

Thermal efficiency, often evaluated with respect to a low thermal conductivity, or “K-factor”, is an important feature of rigid polyurethane foam insulation. Even seemingly small reductions in K-factor, such as on the order of just a few percent, can translate into very significant reductions in energy usage and cost over the lifetime of the device in which the foam is used. For example, according to some estimates, a 2% decrease in K-factor can result in approximately a 1% improvement in energy performance for a refrigerator, which can allow for using a smaller compressor, thus providing potential energy and cost savings over the life of the refrigerator. Alternatively, the thickness of the refrigerator wall or door could be reduced while achieving similar insulation properties, thus allowing for increased internal storage space.

As a result, halogenated olefin-blown rigid polyurethane foams that have improved thermal conductivity, while maintaining favorable foam physical properties and processing characteristics, would be highly desirable.

### SUMMARY

In certain respects, this specification relates to polyurethane foam-forming compositions. These polyurethane foam-forming compositions comprise a polyol blend, a blowing agent composition, and a polyisocyanate. The polyol blend has a weighted average functionality of 3 to 6 and a weighted average hydroxyl number of 300 to 500 mg KOH/g. The blowing agent composition comprises (1) a physical blowing agent and (2) a carbon dioxide-generating chemical blowing agent, in which the physical blowing agent comprises a halogenated olefin that is present (i) in an amount of 1% to 30% by weight, based on total weight of the polyurethane foam-forming composition except for the weight of the polyisocyanate, and (ii) in an amount of at least 80% by weight, based on total weight of physical blowing agent in the blowing agent composition. The physical blowing agent composition and the carbon dioxide generating chemical blowing agent are present in a relative ratio, by weight, of at least 5:1. The polyisocyanate comprises a urethane-modified polyisocyanate having a NCO group content of 25 to 35% by weight, based on the total weight of the urethane-modified polyisocyanate, and comprises a reaction product of components comprising: (1) a polymethylene polyphenyl polyisocyanate; and (2) a monol. The polyisocyanate is present in an amount sufficient to provide an isocyanate index of 0.90 to 1.50

In other respects, this specification relates to methods of producing a polyurethane foam. The methods comprise reacting, at an isocyanate index of 0.90 to 1.50, a polyurethane foam-forming composition comprising a polyol blend, a blowing agent composition, and a polyisocyanate. In these methods, the polyol blend has a weighted average functionality of 3 to 6 and a weighted average hydroxyl number of 300 to 500 mg KOH/g. The blowing agent composition comprises (1) a physical blowing agent and (2) a carbon dioxide-generating chemical blowing agent, in which the physical blowing agent comprises a halogenated olefin that is present (i) in an amount of 1% to 30% by weight, based on total weight of the polyurethane foam-forming composition except for the weight of the polyisocyanate, and (ii) in an amount of at least 80% by weight, based on total weight of physical blowing agent in the blowing agent composition. The physical blowing agent composition and the carbon dioxide generating chemical blowing agent are present in a relative ratio, by weight, of at least 5:1. The polyisocyanate comprises a urethane-modified polyisocyanate having a NCO group content of 25 to 35% by weight, based on the total weight of the urethane-modified polyisocyanate, and comprises a reaction product of components comprising: (1) a polymethylene polyphenyl polyisocyanate; and (2) a monol.

This specification is also directed to rigid polyurethane foams produced from such foam-forming compositions and by such methods, as well as to composite articles comprising such rigid foams and panel insulation that includes such rigid foams.

### DETAILED DESCRIPTION

Various implementations are described and illustrated in this specification to provide an overall understanding of the structure, function, properties, and use of the disclosed inventions. The various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification includes all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described. In the production of polyurethane foams, the hydroxyl groups react with isocyanate groups, —NCO, that are attached to the isocyanate compound. The terms “hydroxyl number” and “OH number” refer to the number of reactive hydroxyl groups available for reaction, and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol—Equivalent Weight (g/eq)=(56.1×1000)/OH number.

Certain implementations of the present specification relate to polyurethane foam-forming composition useful in the production of rigid polyurethane foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers, 1964, page 239.

The polyurethane foams of this specification are the reaction product of a polyurethane-foam forming composition that includes a polyisocyanate. As used herein, the term “polyisocyanate” encompasses diisocyanates, as well as isocyanates of greater functionality than 2.0.

More specifically, in the polyurethane foam-forming compositions of this specification the polyisocyanate comprises a urethane-modified polyisocyanate. The urethane-modified polyisocyanates employed in the polyurethane foam-forming compositions of this specification comprise the reaction product of components comprising: (1) a polymethylene polyphenyl polyisocyanate (‘pMDI”), and (2) a monol. As used herein, the term “monol” means one or more isocyanate-reactive compounds containing an average isocyanate-reactive group functionality of no more than 1.2, such as 0.8 to 1.2. Further, the urethane-modified polyisocyanate described herein is not a polyisocyanate prepolymer. As used herein, a “polyisocyanate prepolymer” refers to a polyisocyanate that is a the reaction product of a polyisocyanate and one or more isocyanate-reactive compounds containing an average isocyanate reactive group functionality of greater than 1.2. Nevertheless, in some implementations, the polyurethane foam-forming compositions of this specification may comprise a polyisocyanate prepolymer in addition to the urethane-modified polyisocyanate described herein.

As will be appreciated, pMDI is a mixture of diphenylmethane diisocyanate (“MDI”) and one or more homologues thereof in which the isocyanate functionality of the homologue(s) is more than 2. In some implementations, the pMDI has an average isocyanate functionality of 2.1 to 3.2, such as 2.5 to 3.2, or, in some cases 2.6 to 3.2 or 2.8 to 3.2. The general formula of pMDI can be represented by the general structure:

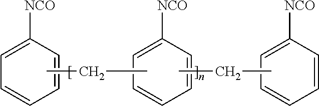

in which n is an integer having a value of 0 or more.

More specifically, in some implementations, the pMDI comprises: i) up to 60% by weight of a first polymethylene polyphenyl polyisocyanate having a general formula (I), based on 100% by weight of the polymethylene polyphenyl polyisocyanate,

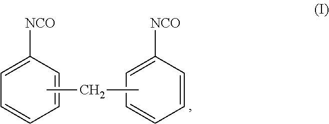

and
at least 40% by weight of a second polymethylene polyphenyl polyisocyanate having a general formula (II), based on 100% by weight of the polymethylene polyphenyl polyisocyanate,

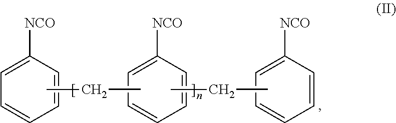

in which n is an integer having a value or 1 or more.

In certain implementations, the pMDI has an NCO content of 25 to 35% by weight, 29 to 34% by weight, or 29.0 to 32.0% by weight, based on the total weight of the urethane-modified polyisocyanate. In addition, in some implementations, the pMDI has a viscosity at 25° C. (measured according to EN ISO 3219, October 1994) of 100 to 750 mPa-s, such as 100 to 600 mPa-s, or 150 to 450 mPa-s.

As indicated, the urethane-modified polyisocyanates present in the polyurethane foam-forming compositions of this specification comprise the reaction product of components comprising the pMDI and a monol. In certain implementations, the monol comprises a compound represented by the structure:

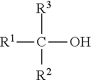

in which R¹, R², and R³ each independently represent H, a C₁-C₅₆ alkyl group, a C₆-C₅₆ aryl group, a C₃-C₅₆ cycloalkyl group, or a C₇-C₅₆ aralkyl group, or the groups R¹, R², and/or R³ may be linked via a ring system. In some implementations, any one or more of R¹, R² and R³ may also represent any of the aforementioned groups that further contain functional groups that do not react with an isocyanate group.

Examples of compounds represented by the foregoing structure include primary alcohols, secondary alcohols, tertiary alcohols, or a combination of any two or more thereof, as well as aromatic monols, aliphatic monols, cycloaliphatic monols, or a combination of any two or more thereof, each of which may be saturated or unsaturated, cyclic, linear or branched. Such alcohols may contain 1 to 56, 1 to 36, 1 to 26, 10 to 15, or 12 to 15 carbon atoms. Specific examples of suitable monols include, without limitation, methanol, ethanol, n-propanol, isopropanol, n-butanol, isobutanol, n-pentanol, 2-hydroxypentane, 3-hydroxypentane, the isomeric primary and secondary methylbutyl alcohols, n-hexanol, n-heptanol, n-octanol, n-nonanol, 2-ethylhexanol, primary and secondary trimethylhexanols, cyclohexanol, alkyl substituted cyclohexanols, cyclopentanol, cyclohexylmethanol, phenol, alkyl substituted phenols (such as nonylphenol), benzyl alcohol, n-decanol, n-undecanol, n-dodecanol, n-tridecanol, n-tetradecanol, n-pentadecanol, n-hexadecanol, n-heptadecanol, n-octadecanol, n-non adecanol, n-eicosanol, n-hexacosanol, n-heptatricontanol, 2,2,4-trimethyl-1-pentanol, 2,6,8-trimethylnonanol, 4-cyclohexyl-1-butanol, 2,4,6-trimethylbenzyl alcohol, 2-methylpropan-2-ol, 2-ethyl-1-butanol, 2-methyl-2-butanol, 2-methyl-3-butene-2-ol, 2-methyl-1-pentanol, 2-methyl-2-pentanol, 3-methyl-3-pentanol, 3-ethyl-3-pentanol, 3-ethyl-3-nonanol, 3-methyl-1-butyn-3-ol, 3-methyl-1-pentyn-3-ol, 2,6-dimethyl-4-heptanol, 3,5-dimethyl-1-hexanol, 3,5-dimethyl-1-hexyn-3-ol, 1-methylcyclopentanol, 1-methylcyclohexanol, 1-ethylcyclohexanol, 1,1-diphenylethnal, 1,1,2-triphenylethanol, t-butyl alcohol, 3-isopropenylcumenol, 2-hydroxystyrene, 3-hydroxytyrene, 4-hydroxystyrene, 4-isopropenylcumenol, 3-isopropenylphenol, 4-isopropenylphenol, p-hydroxy-α-phenylstyrene, p-hydroxy-β-phenylstyrene, 4-hydroxy-α-ethylstyrene, α-chloromethyl-p-hydroxystyrene, allyl alcohol, 2-allylphenol, 2-allyl-6-methylphenol, cinamyl alcohol, undecelenyl alcohols, allylamines, acrylic acids, undecylenic acid, 9-hexadecen-1-ol, 9-octadecen-1-ol, and 10-eicosen-1-ol, as well as mixtures of any two or more thereof. In some implementations, the monol comprises a blend of C₁₂, C₁₃, C₁₄ and C₁₅ primary alcohols which is commercially available from Shell as Neodol 25.

In addition to the foregoing, in some implementations, the monol may include a fluorinated monol, specific examples of which include, without limitation, 2,2,2-trifluoroethanol, 2,2,3,3,3-pentafluoro-1-propanol, 2,2,3,3-tetrafluoro-1-propanol, 4,4,5,5,5-pentafluoro-1-pentanol, 1,1,1,3,3,3-hexafluoro-2-propanol, 3,3,3-trifluoro-1-propanol, 6,6-nonafluoro-1-hexanol, 3,3,4,4,5,5,6,6,7,7,8,8,8-tridecafluoro-1-octanol, 3,3,4,4,5,5,6,6,6-nonafluoro-1-hexanol, 6,6,7,7,8,8,9,9,10,10,11,11,12,12,12-henicosafluoro-1-dodecanol, as well as mixtures of any two or more thereof.

In addition to the monomeric monols listed above, in some implementations, the monol may include higher equivalent weight oligomers or polymers that are derived from such monomeric monols. For example, in some cases, the monol may comprise a polyether monol having an equivalent weight of, for example, at least 850, such as at least 1000, at least 1100 or at least 1200 and up to 10,000, such as up to 7000 or up to 4500. As used herein, the term polyether monol refers to compounds of the above specified equivalent weight range which have a theoretical functionality of 1.0 to 1.2.

Such polyether monols can prepared by condensing an alkylene oxide with a monol initiator. Suitable alkylene oxides include, for example, ethylene oxide, propylene oxide, butylene oxide, amylene oxide, hexylene oxide, aralkylene oxides, such as styrene oxide, and halogenated alkylene oxides, such as trichlorobutylene oxide, as well as combinations of any two or more thereof. Suitable monol initiators include any of the monols described above. In addition to the monofunctional compounds, the initiator may also include a relatively small amount of a di- or higher functional compounds, such as ethylene glycol, propylene glycol, glycerol, and the like. In certain implementations, however, such di- or higher functional compounds are present in an amount of no more than 10% by weight, no more than 5% by weight, or no more than 1% by weight, based on the total weight of initiator used to prepare the polyether monol. In some implementations, monol initiator is present in an amount of at least 90% by weight, at least 95% by weight, or at least 99% by weight, based on total weight of the initiator used to prepare the polyether monol.

The alkoxylation may be performed by a suitable method such as, for example, by base catalysis utilizing strong bases such as sodium hydroxide, potassium hydroxide, sodium methoxide, or potassium methoxide, among others. Other suitable catalysts include diethylzinc, combinations of metal naphthenates and tertiary amines, and the like. In some implementations, the catalyst includes a double metal cyanide (DMC) complex catalysts such as, for example, hexacyanocobaltate·glyme catalysts which are disclosed in U.S. Pat. Nos. 4,843,054 and 5,158,922, and the substantially amorphous zinc hexacyanocobaltate t-butyl alcohol complex catalysts as disclosed in U.S. Pat. No. 5,470,813. In some cases, an amorphous zinc hexacyanocobaltate t-butyl alcohol complex catalysts is used to produce the polyether monol.

In addition to the foregoing compounds, the isocyanate-reactive compounds reacted with pMDI to produce the urethane-modified polyisocyanates employed in the polyurethane foam-forming compositions of this specification may also include a relatively small amount of compounds that have an isocyanate-reactive functionality of greater than 1, such as diols and higher-functional polyols, provided however, that such higher functionality compounds are not employed in an amount sufficient to result in an average isocyanate-reactive group functionality of greater than 1.2 for the compounds reacted with the pMDI. Thus, in some implementations, such di- and/or higher-functional compounds may be present in an amount of up to 10% by weight, such as up to 5% by weight or up to 1% by weight, based on the total weight of isocyanate-reactive compounds reacted with pMDI to produce the urethane-modified polyisocyanate.

Moreover, in some implementations, the monol is characterized by having a relatively high hydrocarbon content. For example, in some implementation, the monol has an hydrocarbon content of at least 50% by weight, at least 60% by weight, at least 70% by weight, at least 80% by weight, at least 90% by weight, or, in some cases at least 95% by weight, based on the total weight of the monol. In addition, the monol has a hydrocarbon content of less than 100% by weight, such as no more than 99.99% by weight, no more 99.9% by weight, no more than 99.5% by weight, or no more than 99% by weight, based on the total weight of the monol. As used herein, “hydrocarbon content” refers to the total weight of all carbon and hydrogen atoms present in a molecule. Thus, for example, in the case of the polyether monols discussed above, “hydrocarbon content” refers to the total weight of all carbon and hydrogen atoms present in the polyether monol and not just the weight of the carbons atoms and hydrogen atoms present in the monol used as a starter to produce the polyether monol.

To prepare the urethane-modified polyisocyanates employed in the polyurethane foam-forming compositions of this specification, the pMDI and the monol are reacted together in relative amounts such that 5 to 5000, such as 7 to 4500, NCO equivalents are present for each OH equivalent that is present. Any suitable reaction temperature may be employed, such as a temperature of 20° C. to 100° C. or 40° C. to 80° C.

As indicated, in the foam-forming compositions of this specification, the polyisocyanate is present in an amount sufficient to provide an isocyanate index of 0.90 to 1.50, such as 1.20 to 1.50. In some implementations, the foregoing urethane-modified polyisocyanate is essentially the sole polyisocyanate present in the polyurethane foam-forming composition. Therefore, in these implementation, the urethane-modified polyisocyanate is present in the polyurethane foam-forming composition in an amount sufficient to provide an isocyanate index of 0.90 to 1.50, such as 1.20 to 1.50.

The polyurethane foam-forming compositions described in this specification also comprise a polyol blend. The polyol blend has a weighted average functionality of 3 to 6, 3 to 5, 3.5 to 4.5, or 3.8 to 4.2, and/or a weighted average hydroxyl number of 300 to 500 mg KOH/g, such as 350 to 450 mg KOH/g. In certain embodiments, the polyol blend is present in the polyurethane foam-forming composition in an amount of at least 50% by weight, such as 50 to 90% by weight or 60 to 80% by weight, based on the total weight of the polyurethane foam-forming composition except for the weight of polyisocyanate that is present.

More specifically, in some implementation, the polyol blend comprises an amine-initiated polyether polyol. As used herein, “amine-initiated polyether polyol” refers to a polyether polyol that is the reaction product of an H-functional starter comprising an amine, such as aliphatic amines and/or aromatic amines, and alkylene oxide. In some embodiments, the amine starter comprises an aromatic amine. As used herein, “aromatic amine-initiated polyether polyol” refers to a polyether polyol that is the reaction product of an H-functional starter comprising an aromatic amine, such as toluenediamine (“TDA”), with alkylene oxide. In some of these implementations, however, the amine H-functional starter used to prepare the amine-initiated polyether polyol is not an alkanolamine and, as a result, in some of these cases, the amine-initiated polyether polyol is distinct from the alkanolamine-initiated polyether polyol described below.

In certain implementations, the amine employed has an amine functionality of at least 2, such as 2 to 3. Specific examples of suitable (cyclo)aliphatic amine starters include, without limitation, 1,2-ethylenediamine, 1,3-propylenediamine, 1,4-butylenediamine, 1,6-hexamethylenediamine, diethylenetriamine, pentane diamine, isophorone diamine, 1,10-decanediamine and diaminocyclohexylmethane, pentamethylenediamine, and combinations of any two or more thereof. Specific examples of suitable aromatic amines which can be used include crude TDA obtained by the nitration of toluene followed by reduction; 2,3-TDA, 3,4-TDA, 2,4-TDA, 2,6-TDA or mixtures thereof; aniline; 4,4′-methylene dianiline; methylene-bridged polyphenyl polyamines composed of isomers of methylene dianilines and triamines or polyamines of higher molecular weight prepared by reacting aniline with formaldehyde by methods known in the art. In some implementations, a mixture composed of 2,3-TDA and 3,4-TDA (commonly referred to as “o-TDA”) is used.

In addition to the amine, other H-functional starters may also be used to prepare the amine-initiated polyether polyol. These other H-functional starters include, for example, water, propylene glycol, glycerin, ethylene glycol, ethanol amines, diethylene glycol, or a mixture of any two or more thereof. As will be appreciated, it is possible to use a wide variety of individual starters in combination with one another. In some implementations, however, amine, in some cases aromatic amine, is the predominant or essentially sole H-functional starter used to produce the amine-initiated polyether polyol. This means that, in these implementations, amine, in some cases aromatic amine, is present in an amount of more than 50% by weight, such as at least 80% by weight, at least 90% by weight, or even 100% by weight, based on the total weight of H-functional starter used to produce the amine-initiated polyether polyol.

A variety of alkylene oxides may be used to produce the amine-initiated polyether polyol, such as ethylene oxide, propylene oxide, butylene oxide, amylene oxide and mixtures thereof. The alkylene oxides may be added individually, sequentially one after the other to form blocks or in a mixture to form a heteric polyether. The amine-initiated polyether polyols may have primary or secondary hydroxyl end groups. In some implementations, propylene oxide is the primary or essentially sole alkylene oxide used to prepare the amine-initiated polyether polyol. This means that, in these implementations, propylene oxide is used in an amount of more than 50% by weight, such as at least 80% by weight, at least 90% by weight, or even 100% by weight, based on the total weight of alkylene oxide used to prepare the amine-initiated polyether polyol. In some implementations, ethylene oxide is employed in a relatively small amount. In these implementations, ethylene oxide is used in an amount of no more than 10% by weight, no more than 5% by weight, no more than 1% by weight, or, in some cases, 0% by weight, based on the total weight of alkylene oxide used to prepare the amine-initiated polyether polyol.

In some implementation, the amine-initiated polyether polyol has an OH number of 200 to 600 mg KOH/g and a functionality of at least 2.5. In some implementations, the amine-initiated polyether polyol has an OH number of 300 to 500 mg KOH/g, such as 380 to 420 mg KOH/g and an average functionality of 3.5 to 4.5, 3.8 to 4.2 or 4.0. In addition, the amine-initiated polyether polyol, in some implementations, has a content of —C₂H₄O— units of less than 10% by weight, such as less than 5% by weight, less than 2% by weight, or, in some cases, 0% by weight, based on total weight of the amine-initiated polyether polyol.

In some embodiments, the amine-initiated, such as aromatic amine-initiated, polyether polyol is present in an amount of at least 30% by weight, based on the total weight of the polyol blend. More specifically, in some implementations, the amine-initiated, such as aromatic amine-initiated, polyether polyol is present in an amount of 30 to 80% by weight, such as 30 to 60% by weight, or, in some cases, 40 to 60% by weight or 40 to 50% by weight, based on the total weight of the polyol blend.

Moreover, in some cases, the polyol blend also includes a saccharide-initiated polyether polyol. As used herein, “saccharide-initiated polyether polyol” refers to a polyether polyol that is the reaction product of an H-functional starter comprising saccharide, such as sucrose, with alkylene oxide. Examples of suitable alkylene oxides include those mentioned earlier with respect to the amine-initiated polyether polyol. Some examples of suitable saccharide initiators are sucrose, sorbitol, maltitol, etc. as well as other mono-saccharides, di-saccharides, tri-saccharides and polysaccharides. Other initiator compounds are often used in combination with the saccharide initiator to prepare the saccharide initiated polyether polyol. Saccharides can be co-initiated with for example, compounds such as water, propylene glycol, glycerin, ethylene glycol, ethanol amines, diethylene glycol, or a mixture of any two or more thereof, however, in some cases, little or no amine initiator is used to prepare the saccharide-initiated polyether polyol. As will be appreciated, it is possible to use a wide variety of individual initiator compounds in combination with saccharide initiator.

In some implementations, saccharide is the predominant H-functional starter used to produce the saccharide-initiated polyether polyol. This means that, in these implementations, saccharide is present in an amount of more than 50% by weight, such as at least 70% by weight or at least 80% by weight, based on the total weight of H-functional starter used to produce the saccharide-initiated polyether polyol.

In some implementations, propylene oxide is the primary or essentially sole alkylene oxide used to prepare the saccharide-initiated polyether polyol. This means that, in these implementations, propylene oxide is used in an amount of more than 50% by weight, such as at least 60% by weight, or at least 70% by weight, based on the total weight of alkylene oxide used to prepare the saccharide-initiated polyether polyol. In some implementations, ethylene oxide is employed in a relatively small amount. Thus, in these implementations, ethylene oxide is present in an amount of no more than 50% by weight, such as no more than 40% by weight, or, in some cases, no more than 30% by weight, based on the total weight of alkylene oxide used to prepare that saccharide-initiated polyether polyol.

In some implementations, the saccharide-initiated polyether polyol has an OH number of 200 to 600 mg KOH/g, 300 to 550 mg KOH/g, 380 to 500 mg KOH/g, or, in some cases, 450 to 500 mg KOH/g, and a functionality of 4 to 6, such as 5 to 6, 5.2 to 5.8, or 5.2 to 5.6. In addition, in some implementations, the saccharide-initiated polyether polyol has a content of —C₂H₄O— units of less than 50% by weight, such as less than 40% by weight, or no more than 30% by weight, based on total weight of the saccharaide-initiated polyether polyol.

In some embodiments, the saccharide-initiated polyether polyol is present in an amount of at least 30% by weight, based on the total weight of the polyol blend. More specifically, in some cases, the saccharide-initiated polyol is present in an amount of 30 to 60% by weight, such as 30 to 50% by weight, or, in some cases, 35 to 45% by weight, based on the total weight of the polyol blend.

In some embodiments, the polyol blend may include an aliphatic triol-initiated polyether polyol. As used herein, “aliphatic-triol-initiated polyether polyol” refers to a polyether polyol that is the reaction product of an H-functional starter comprising an aliphatic triol, such as glycerin, with alkylene oxide. Examples of suitable alkylene oxides include alkylene oxides include those mentioned earlier with respect to the amine-initiated polyether polyol. Other initiator compounds may be used in combination with the aliphatic triol initiator to prepare the aliphatic triol-initiated polyether polyol. Aliphatic triols can be co-initiated with for example, compounds such as water, propylene glycol, sucrose, ethylene glycol, diethylene glycol, or a mixture of any two or more thereof, however, in some cases, little or no amine initiator and no saccharide initiator is used to prepare the aliphatic triol-initiated polyether polyol. As will be appreciated, it is possible to use a wide variety of individual initiator compounds in combination with aliphatic triol initiator.

In some implementations, aliphatic triol is the predominant H-functional starter used to produce the aliphatic triol-initiated polyether polyol. This means that, in these implementations, aliphatic triol is present in an amount of more than 50% by weight, such as at least 70% by weight or at least 80% by weight, based on the total weight of H-functional starter used to produce the aliphatic triol-initiated polyether polyol.

In some implementations, propylene oxide is the primary or essentially sole alkylene oxide used to prepare the aliphatic triol-initiated polyether polyol. This means that, in these implementations, propylene oxide is used in an amount of more than 50% by weight, such as at least 60% by weight, or at least 70% by weight, based on the total weight of alkylene oxide used to prepare the aliphatic triol-initiated polyether polyol. In some implementations, ethylene oxide is employed in a relatively small amount. Thus, in these cases, ethylene oxide is present in an amount of no more than 50% by weight, such as no more than 40% by weight, or, in some cases, no more than 30% by weight, based on the total weight of alkylene oxide used to prepare that aliphatic triol-initiated polyether polyol.

In some embodiments, the aliphatic triol-initiated polyether polyol has an OH number of 100 to 500 mg KOH/g, such as 200 to 400 mg KOH/g, 200 to 300 mg KOH/g, 200 to 250 mg KOH/g, 230 to 250 mg KOH/g or 233 to 243 mg KOH/g, and a functionality of greater than 2 to 4, such as 2.5 to 3.5, or, in some cases, 3.0. In addition, in some implementations, the aliphatic triol-initiated polyether polyol has a content of —C₂H₄O— units of less than 50% by weight, such as less than 40% by weight, or no more than 30% by weight, based on total weight of the aliphatic triol-initiated polyether polyol.

In some embodiments, the aliphatic triol-initiated polyether polyol is present in an amount of at least 30% by weight, based on the total weight of the polyol blend. More specifically, in some cases, the aliphatic triol-initiated polyol is present in an amount of 30 to 60% by weight, such as 30 to 50% by weight, or, in some cases, 35 to 45% by weight, based on the total weight of the polyol blend.

In addition, in some cases, the polyol blend may comprise an alkanolamine-initiated polyether polyol. As used herein, “alkanolamine-initiated polyether polyol” refers to a polyether polyol prepared by reacting at least one alkylene oxide with one or more suitable initiator compounds in the presence of a suitable catalyst, in which the initiator compounds comprise one or more alkanolamines. Suitable catalysts including basic catalysts (such as sodium or potassium hydroxide or tertiary amines such as methyl imidazole) and DMC catalysts. In the polyol blends described herein, each of the recited polyether polyols, including the “alkanolamine-initiated polyether polyol” and the “aliphatic amine-initiated polyether polyol”, are different from each other.

As used herein, the term “alkanolamine” refers to compounds represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms. The dialkylene ether radical may be represented by the formula:

—R—O—R—

where each R represents a hydrocarbon radical having 2 to 3 carbon atoms.

Specific examples of suitable alkanolamines that may be used in the preparation of the alkanolamine-initiated polyether polyol include monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, as well as mixtures of any two or more thereof. In some implementations, alkanolamine is the predominant H-functional starter used to produce the alkanolamine-initiated polyether polyol. This means that, in these implementations, alkanolamine is present in an amount of more than 50% by weight, such as at least 70% by weight or at least 80% by weight, based on the total weight of H-functional starter used to produce the alkanolamine-initiated polyether polyol.

In some implementations, propylene oxide is the primary or essentially sole alkylene oxide used to prepare the alkanolamine-initiated polyether polyol. This means that, in these implementations, propylene oxide is used in an amount of more than 50% by weight, such as at least 60% by weight, or at least 70% by weight, based on the total weight of alkylene oxide used to prepare the alkanolamine-initiated polyether polyol. In some implementations, ethylene oxide is employed in a relatively small amount. Thus, in these cases, ethylene oxide is present in an amount of no more than 50% by weight, such as no more than 40% by weight, or, in some cases, no more than 30% by weight, based on the total weight of alkylene oxide used to prepare that alkanolamine-initiated polyether polyol.

In some implementations, the alkanolamine-initiated polyether polyol has an OH number of at least 500 mg KOH/g, such as 500 to 900 mg KOH/g, 600 to 800 mg KOH/g, or, in some cases, 680 to 720 mg KOH/g, and a functionality of 2.5 to 4, such as 2.5 to 3.5.

The polyol blend may, if desired, include other compound with isocyanate-reactive groups, such as chain extenders and/or crosslinking agents, and higher molecular weight polyether polyols and polyester polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine. Polyester polyols may be prepared from, for example, an organic dicarboxylic acid having 2 to 12 carbon atoms, such as an aliphatic dicarboxylic acid having 4 to 6 carbon atoms, and a polyvalent alcohol, such as a diol or triol having 2 to 12 carbon atoms. Examples of the dicarboxylic acid are succinic acid, glutaric acid, adipic acid, suberic acid, azelaic acid, sebacic acid, decanedicarboxylic acid, maleic acid, fumaric acid, phthalic acid, isophthalic acid and terephthalic acid. Instead of a free dicarboxylic acid, a corresponding dicarboxylic acid derivative such as a dicarboxylic acid monoester or diester prepared by esterification with an alcohol having 1 to 4 carbon atoms or dicarboxylic anhydride can be used.

In some embodiments, the polyol blend has a content of —C₂H₄O— units of 3 to 6%, such as 4 to 6% by weight, based on total weight of the polyurethane foam-forming composition. As used herein, “a content of —C₂H₄O— units” refers to the calculated weight of —C₂H₄O— units present in a polyol that are formed during production of the polyol itself (as opposed to —C₂H₄O— units that may already be present in a reactant used to prepare the polyol). In the case of a polyether polyol that is an alkoxylation reaction product of an H-functional starter and an alkylene oxide, for example, —C₂H₄O— units can result from use of ethylene oxide as an alkylene oxide and/or use of an H-functional starter containing a —C₂H₄Z— group in which Z represents a Zerewitinoff-active hydrogen atom (sometimes also referred to merely as “active hydrogen”), such as can be the case where Z represents a hydrogen bonded to N, O or S. In the case of a polyester polyol that is a reaction product of a carboxylic acid and/or anhydride thereof with a hydroxyl-containing material, —C₂H₄Z— units may result, for example, from use of diethylene glycol as a hydroxyl-containing material. Thus, when stated herein that a polyol blend has a content of —C₂H₄O— units of 3 to 6% by weight, based on total weight of the polyurethane foam-forming composition, it means that 3 to 6% by weight of the polyurethane foam-forming composition, based on total weight of the polyurethane foam-forming composition, is —C₂H₄O— units formed during production of the polyol(s) that are used, as calculated based on the weight of materials used to make the polyols.

As indicated, the polyurethane foam-forming compositions of this specification further comprises a physical blowing agent composition comprising a halogenated olefin. More specifically, in some implementations, the halogenated olefin comprises a hydrofluoroolefin (“HFO”), a hydrochlorofluoroolefins (“HCFOs”), or a combination thereof. Suitable such halogenated olefins include, without limitation, 1,1,1,4,4,4-hexafluoro-2-butene (cis and/or trans isomers), 1-chloro-3,3,3-trifluoropropene (HCFO-1233zd, E and/or Z isomers), 2-chloro-3,3,3-trifluoropropene (HCFO-1233xf), HCFO1223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers), and 2-chloro-1,1,1,3,4,4,4-heptafluorobutene-2 (E and/or Z isomers), or a combination of any two or more thereof.

In some implementations, the halogenated olefin is present in an amount of 1 to 30% by weight, such as 5 to 30% by weight, 10 to 30% by weight or 15 to 25% by weight or 18 to 22% by weight, based on the total weight of the polyurethane foam-forming composition except for the weight of the polyisocyanate.

If desired, the isocyanate-reactive composition may include one or more other physical blowing agents, such as other halogenated blowing agents, such as CFCs, HCFCs, and HFCs, and/or hydrocarbon blowing agents, such as butane, n-pentane, cyclopentane, hexane, and/or isopentane (i.e. 2-methylbutane). In other embodiments, however, the isocyanate-reactive composition is substantially or, in some cases, completely free, of such other physical blowing agents. Therefore, in some implementations, the halogenated olefin, such as HCFO, is present in amount of at least 80% by weight, such as at least 90% by weight, at least 95% by weight, at least 99% by weight or, in some cases 100% by weight, based on the total weight of the physical blowing agent in the blowing agent composition.

The polyurethane foam-forming compositions of this specification include a carbon dioxide generating chemical blowing agent, such as water and/or a formate-blocked amine, is also included. In some of these implementations, the carbon dioxide generating chemical blowing agent, such as water, is utilized in an amount of 0.5 to 5.0% by weight, such as 1 to 3% by weight, or 1.0 to 2.0% by weight, or 1.2 to 1.8% by weight, based on the total weight of the polyurethane foam-forming composition except for the weight of the polyisocyanate.

In certain implementations, the physical blowing agent composition and the carbon dioxide generating chemical blowing agent are present in a relative ratio, by weight, of at least 5:1, such as 5:1 to 50:1, 5:1 to 20:1 or, in some cases, 10:1 to 15:1.

The polyurethane foam-forming composition also typically comprises a surfactant. Suitable surfactant include, for example, organosilicon compounds, such as polysiloxane-polyalkyene-block copolymers, such as a polyether-modified polysiloxane. Other possible surfactants include polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. In some implementations, surfactant is utilized in an amount of 0.2 to 5.0% by weight, such as 1 to 3% by weight, based on the total weight of the polyurethane foam-forming composition except for the weight of the polyisocyanate.

The polyurethane foam-forming compositions of this specification also typically comprise a catalyst, such as a tertiary amine, tertiary phosphine, a metal chelate, an acid metal salt, a strong base, a metal alcoholate and/or phenolate, a metal salt of an organic acid, or a combination thereof. In some implementations, the catalyst comprises an organotin catalyst and/or tertiary amine catalyst. For example, in some cases, a combination of at least one “blowing” catalyst, which strongly promotes the reaction of an isocyanate group with a water molecule to form carbon dioxide, and either at least one “gelling” catalyst, which strongly promotes the reaction of an alcohol group with an isocyanate to form the urethane, or at least one trimerization catalyst, may be used.

Specific examples of suitable tertiary amine catalysts include: pentamethyldiethylenetriamine, N,N-dimethylcyclohexylamine, N,N′,N″-tris(3-dimethylaminopropyl-)hexahydrotriazine, tetramethylethylenediamine, tetraethylene diamine, benzyldimethylamine or a combination thereof. In certain embodiments, the tertiary amine catalyst includes pentamethyldiethylenetriamine, N,N′,N″-dimethylaminopropyl-hexahydrotriazine, N,N-dimethylcyclohexylamine, or a combination thereof. Specific examples of suitable organometallic catalysts include dibutyltin dilaurate, dibutyltin diacetate, stannous octoate, potassium octoate, potassium acetate, potassium 2-ethylhexanoate, or a combination thereof. In some implementations, catalyst is present in an amount of 0.01 to 3.0% by weight or 0.3 to 2.5% by weight, based on the total weight of the polyurethane foam-forming composition except for the weight of the polyisocyanate.

Additional materials which may optionally be included in the foam-forming compositions of the present invention include: pigments, colorants, fillers, antioxidants, flame retardants, and stabilizers. Exemplary flame retardants useful in the foam-forming composition of the present invention include, but are not limited to, reactive bromine based compounds known to be used in polyurethane chemistry and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

This specification is also directed to processes for producing rigid polyurethane foams. In such processes, a polyisocyanate is reacted with an isocyanate-reactive composition comprising the polyol blend. In some implementations, the isocyanate functional component and the polyol blend are mixed at an isocyanate index of 0.90 to 1.50, such as 1.20 to 1.50.

The polyol blend is reacted with an polyisocyanate in the presence of the blowing agent composition, the catalyst composition, a surfactant and any other optional ingredients. The rigid foams may be prepared by blending all of the polyurethane foam-forming composition components, except for the polyisocyanate, together in a phase stable mixture, and then mixing this mixture in the proper ratio with the polyisocyanate. Alternatively, one or more of the components, such as the surfactant, may be combined with the polyisocyanate prior to mixing it with the polyol blend. Other possible implementations would include adding one or more of the components as a separate stream, together with the polyol blend and polyisocyanate. As used herein, the term phase stable means that the composition does not visibly separate when stored for 7 days at about 70° F. (or 21° C.).

Many foam machines are designed to condition and mix only two components in the proper ratio. For use of these machines, a premix of all the components except the polyisocyanate can be advantageously employed. According to the two-component method (component A: polyisocyanate; and component B: isocyanate-reactive composition which typically includes the polyol blend, blowing agent, water, catalyst and surfactant), the components may be mixed in the proper ratio at a temperature of 5 to 50° C., such as 15 to 35° C., injected or poured into a mold having the temperature controlled to within a range of 20 to 70° C., such as 35 to 60° C. The mixture then expands to fill the cavity with the rigid polyurethane foam. This simplifies the metering and mixing of the reacting components which form the foam-forming mixture, but requires that the isocyanate reactive composition be phase stable.

Alternatively, the rigid polyurethane foams may also be prepared by the so-called “quasi prepolymer” method. In this method, a portion of the polyol component is reacted in the absence of the urethane-forming catalysts with the polyisocyanate component in proportion so as to provide 10% to 35% of free isocyanate groups in the reaction product based on the prepolymer. To prepare foam, the remaining portion of the polyol is added and the components are allowed to react together in the presence of the blowing agent and other appropriate additives such as the catalysts, and surfactants. Other additives may be added to either the isocyanate prepolymer or remaining polyol or both prior to the mixing of the components, whereby at the end of the reaction, rigid foam is provided.

Furthermore, the rigid foam can be prepared in a batch or continuous process by the one-shot or quasi-prepolymer methods using any well-known foaming apparatus. The rigid foam may be produced in the form of slab stock, moldings, cavity fillings, sprayed foam, frothed foam or laminates with other materials such as hardboard, plasterboard, plastics, paper or metal as facer substrates.

For closed-cell insulating foams, the object is to retain the blowing agent in the cells to maintain a low thermal conductivity of the insulating material, i.e., the rigid foam. Thus, high closed-cell content is desirable. In some implementations, the rigid foams produced according to implementations of this specification have a closed-cell content of more than 80 percent, more than 85 percent, or more than 88 percent, as measured according to ASTM D6226-15. Furthermore, the thermal conductivity of foams produced according to various implementations of the present specification indicates that the foams have acceptable insulating properties, i.e., the foams have a thermal conductivity measured at 35° F. (2° C.) of less than 0.126 BTU-in/h-ft²-° F. and measured at 75° F. (24° C.) of less than 0.140 BTU-in/h-ft²-° F. for foam from the core of 2-inch thick panels, as measured according to ASTM C518-15.

This specification also relates to the use of the rigid foams described herein for thermal insulation. That is, the rigid foams of the present specification may find use as an insulating material in refrigeration apparatuses. These rigid foams can be used, for example, as an intermediate layer in composite elements or for filling hollow spaces of refrigerators and freezers, or refrigerated trailers. These foams may also find use in the construction industry or for thermal insulation of long-distance heating pipes and containers.

As such, the present invention also provides a composite article comprising rigid foam as disclosed herein sandwiched between one or more facer substrates. In certain implementations, the facer substrate may be plastic (such a polypropylene resin reinforced with continuous bi-directional glass fibers or a fiberglass reinforced polyester copolymer), paper, wood, or metal. For example, in certain implementations, the composite article may be a refrigeration apparatus such as a refrigerator, freezer, or cooler with an exterior metal shell and interior plastic liner. In certain implementations, the refrigeration apparatus may be a trailer, and the composite article may include the foams produced according to the present invention in sandwich composites for trailer floors or sidewalls.

It has been found, surprisingly, that the particular polyurethane foam-forming compositions described herein are capable of producing rigid polyurethane foams with significantly improved thermal insulation properties (as determined by K-factor measurements), while still retaining other important foam properties and processing characteristics, such as dimensional stability, compressive strength, flow, reactivity and de-mold characteristics.

The non-limiting and non-exhaustive examples that follow are intended to further describe various non-limiting and non-exhaustive implementations without restricting the scope of the implementations described in this specification.

### Examples

The present invention is further illustrated, but is not to be limited, by the following examples. The following materials were used in the Examples:
Polyol 1: An ortho-toluenediamine initiated polyether polyol (63% propylene oxide/37% ethylene oxide epoxide block) having an OH number of 388 mg KOH/g and an average functionality of 4;
Polyol 2: A sucrose/glycerine/propylene glycol/water initiated polyether polyol (100% propylene oxide) having an OH number of 410 mg KOH/g and an average functionality of 4.28;
Polyol 3: A sucrose/glycerine initiated polyether polyol (100% propylene oxide) having an OH number of 470 mg KOH/g and an average functionality of 4.66;
Polyol 4: An ortho-toluenediamine initiated polyether polyol (100% propylene oxide) having an OH number of 400 mg KOH/g and an average functionality of 4;
Polyol 5: An ethylenediamine initiated polyether polyol (100% propylene oxide) having an OH number of 60 mg KOH/g and an average functionality of 3.71;
Polyol 6: A sucrose/propylene glycol/water initiated polyether polyol (100% propylene oxide) having an OH number of 470 mg KOH/g and an average functionality of 5.24;
Polyol 7: A sucrose/water initiated polyether polyol (100% propylene oxide) having an OH number of 380 mg KOH/g and an average functionality of 5.81;
Polyol 8: A monoethanolamine initiated polyether polyol (100% propylene oxide) having an OH number of 700 mg KOH/g and an average functionality of 3.0;
Polyol 9: A glycerine initiated polyether polyol (100% propylene oxide) having an OH number of 470 mg KOH/g and an average functionality of 3.0;
Polyol 10: A sucrose/water initiated polyether polyol (70% propylene oxide/30% ethylene oxide block) having an OH number of 470 mg KOH/g and an average functionality of 5.52;
Polyol 11: A glycerine initiated polyether polyol (100% propylene oxide) having an OH number of 112 mg KOH·g and an average functionality of 3;
Polyol 12: A glycerine initiated polyether polyol (100% propylene oxide) having an OH number of 240 mg KOH/g and an average functionality of 3.0;
Polyol 13: An aromatic polyester polyol having an OH number of 230-250 mg KOH/g and a functionality of 2 (commercially available from Stepan Company as STEPANPOL® PS-2502A);
Alcohol 1: a C12-C15 primary alcohol blend with a hydroxyl number 267-276, Neodol™ 25 from Shell Chemicals;
Alcohol 2: Tridecafluoro-1-octanol, Capstone 62™ Alcohol commercially available from Chemours;
Surfactant 1: silicone surfactant with a hydroxyl number of 54 mg KOH/g, Vorasurf™ DC 5357 from Dow;
Surfactant 2: a polyorganosiloxane polyether copolymer believed to have a hydroxyl number of 105 mg KOH/g, available as Tegostab® B-8465 from Evonik;
Surfactant 3: non-hydrolyzable silicone surfactant with a hydroxyl number of 66 mg KOH/g, Niax™ L-5440 from Momentive;
Surfactant 4: silicone surfactant with a hydroxyl number of 110 mg KOH/g, available as Tegostab® B-8499 from Evonik;
Catalyst 1: N,N,N′,N″,N″-pentamethyldiethylenetriamine, Polycat™ 5 from Evonik;
Catalyst 2: a solution of potassium-octoate in diethylene glycol, Dabco® K-15 from Evonik;
Catalyst 3: N,N-Dimethylcyclohexylamine, Polycat™ 8 from Evonik;
Catalyst 4: N,N′,N″-tris(dimethylaminopropyl)hexahydrotriazine, Polycat™ 41 from Evonik;
Catalyst 5: (2-Hydroxypropyl)trimethylammonium formate, Dabco® TMR-2 from Evonik;
Catalyst 6: 2,2′-dimorpholinodiethylether, JEFFCAT® DMDEE from Huntsman;
Catalyst 7: 1,2-dimethylimidazole, Dabco® 2041 from Evonik;
Catalyst 8: N-methylmorpholine, JEFFCAT® NMM from Huntsman;
Catalyst 9: N,N-Dimethylbenzylamine, Addocat® DB from Lanxess;
Additive 1: Tris (2-chloroisopropyl) phosphate, Fyrol™ PCF from ICL Industrial Products;
Blowing Agent 1: cyclopentane;
Blowing Agent 2: trans-1,1,1-trifluoro-3-chloropropene, Solstice® LBA from Honeywell International Inc.;
Isocyanate 1: polymeric diphenylmethane diisocyanate (pMDI); NCO weight 31.5%; viscosity 200 mPa-s @25° C. (MONDUR® MR from Covestro);
Isocyanate 2: polymeric diphenylmethane diisocyanate (pMDI); NCO weight 31.3%; viscosity 400 mPa-s @25° C. (MONDUR® 44V40 from Covestro);
Isocyanate 3: Prepared by adding Isocyanate 1 (3000 g) to a 5-L 3-neck flask with stirring under nitrogen, heating Isocyanate 1 to 60° C., adding Alcohol 1 (180 g) dropwise, maintaining the solution temperature at 60° C., and continuing heating for 1 hour to give Isocyanate 3 with an isocyanate content of 27.1% and 413 mPa·s@25° C. viscosity;
Isocyanate 4: Prepared by adding Isocyanate 1 (3000 g) to a 5-L 3-neck flask with stirring under nitrogen, heating Isocyanate 1 60° C., adding Alcohol 2 (240 g) dropwise, maintaining the solution temperature at 60° C., and continuing heating for 1 hour to give Isocyanate 4 with an isocyanate content of 26.8% and 358 mPa·s@25° C. viscosity;
Isocyanate 5: Prepared by adding Isocyanate 1 (3000 g) to a 5-L 3-neck flask with stirring under nitrogen, heating Isocyanate 1 to 60° C., adding Alcohol 1 (75 g) dropwise, maintaining the solution temperature at 60° C., and continuing heating for 1 hour to give Isocyanate 5 with an isocyanate content of 29.5% and 261 mPa·s@25° C. viscosity; and
Isocyanate 6: Prepared by adding Isocyanate 1 (3000 g) to a 5-L 3-neck flask with stirring under nitrogen, heating Isocyanate 1 to 60° C., adding Alcohol 2 (90 g) dropwise, maintaining the solution temperature at 60° C., and continuing heating for 1 hour to give Isocyanate 6 with an isocyanate content of 30.2% and 266 mPa·s@25° C. viscosity.

In each case, a master batch was prepared by mixing the polyols, catalysts, surfactant, water and blowing agents in the amounts indicated in Table 1. Foams were prepared by mixing the masterbatch with the Isocyanate in an amount sufficient to provide the isocyanate index listed in Table 1 and pouring the mixture into an 83 ounce paper cup. The cream time, gel time, tack-free time and free rise density (“FRD”) were recorded.

Foam panels were also prepared by hand using an air-powered mixer (~3000 rpm) and utilizing a temperature controlled mold (120° F.; dimensions of 25″×13″×2″). The isocyanate-reactive composition and isocyanate temperatures were maintained at 25° C. and all samples were demolded after 3 minutes. Minimum fill was determined by slightly overfilling the mold cavity and then removing the excess foam such that the foam weight contained in the 25″×13″×2″ volume could be measured. After determining the minimum fill value, foam panels were prepared to obtain a desired density approximately 8-12% over the minimum fill density. Results are in Table 1.

Results in Table 1 represent the average results of three replicate experiments. Examples 2-3, 5-6 and 8, 10-11, 13, 15, and 17 are inventive examples and Examples 1, 4, 7, 9, 12, 14, and 16 are comparative examples.

TABLE 1

| Material | 1 | 2 | 3 | 4 | 5 | 6 | 7 | 8 |
|---|---|---|---|---|---|---|---|---|
| Polyol 1 | 33.04 | 33.04 | 33.04 | 30.08 | 33.04 | 33.04 | — | — |
| Polyol 4 | — | — | — | — | — | — | 32.45 | 32.45 |
| Polyol 7 | 22.12 | 22.12 | 22.12 | 20.13 | 22.12 | 22.12 | | |
| Polyol 10 | — | — | — | — | — | — | 29.66 | 29.66 |
| Polyol 13 | 18.36 | 18.36 | 18.36 | 16.71 | 18.36 | 18.36 | 10.86 | 10.86 |
| Alcohol 1 | — | — | — | 6.60 | — | — | — | — |
| Surfactant 1 | 2.90 | 2.90 | 2.90 | 2.90 | 2.90 | 2.90 | 2.90 | 2.90 |
| Catalyst 1 | 0.90 | 0.90 | 0.90 | 0.90 | 0.90 | 0.90 | 0.85 | 0.85 |
| Catalyst 2 | 0.90 | 0.90 | 0.90 | 0.90 | 0.90 | 0.90 | 0.76 | 0.76 |
| Water | 1.70 | 1.70 | 1.70 | 1.70 | 1.70 | 1.70 | 1.52 | 1.52 |
| Blowing Agent 2 | 20.08 | 20.08 | 20.08 | 20.08 | 20.08 | 20.08 | 21.00 | 21.00 |
| Isocyanate No. | 1 | 3 | 5 | 1 | 4 | 6 | 1 | 3 |
| Index | 1.32 | 1.14 | 1.24 | 1.34 | 1.12 | 1.27 | 1.22 | 1.05 |
| Ratio | 1.15 | 1.15 | 1.15 | 1.15 | 1.15 | 1.15 | 1.14 | 1.14 |
| Cream (s) | 9 | 10 | 8 | 10 | 9 | 9 | 9 | 8 |
| Gel (s) | 49 | 60 | 50 | 45 | 51 | 50 | 50 | 51 |
| Tack-Free (s) | 89 | 170 | 134 | 228 | 138 | 170 | 55 | 49 |
| Free-Rise Density (pcf) | 1.58 | 1.67 | 1.55 | 1.57 | 1.62 | 1.57 | 1.83 | 1.66 |
| Min. Fill Density (pcf) | 1.76 | 1.78 | 1.78 | 1.77 | 1.79 | 1.77 | 1.86 | 1.81 |
| Packed Density (pcf) | 1.92 | 1.97 | 1.98 | 1.98 | 2.00 | 1.94 | 2.06 | 1.96 |
| Packed/Core Ratio | 1.10 | 1.11 | 1.11 | 1.14 | 1.12 | 1.13 | 1.08 | 1.10 |
| k-Factor ((BTU · in)/(h · ft² · °F)) @ | 0.119 | 0.115 | 0.123 | 0.127 | 0.120 | 0.119 | 0.119 | 0.114 |
| 35 °F | | | | | | | | |
| k-Factor ((BTU · in)/(h · ft² · °F)) @ | 0.137 | 0.131 | 0.140 | 0.145 | 0.136 | 0.136 | 0.134 | 0.130 |
| 75 °F | | | | | | | | |
| Closed Cell Content (%) | 88.2 | 89.4 | 88.3 | 86.3 | 85.4 | 89.1 | 87.2 | 86.7 |
| Core Density (pcf) | 1.75 | 1.78 | 1.78 | 1.74 | 1.78 | 1.71 | 1.90 | 1.78 |
| Compressive Strength + (psi) | 15.6 | 14.6 | 17.6 | 17.1 | 10.8 | 13.3 | 20.3 | 10.9 |
| Compressive Strength = (psi) | 32.3 | 30.3 | 35.7 | 33.6 | 19.4 | 24.4 | 36.5 | 29.1 |
| Dimensional Stability | −0.1 | 0.0 | −0.3 | −0.7 | −0.1 | 0.0 | 0.1 | −0.4 |
| 1 Day @ −30 °C | | | | | | | | |
| Dimensional Stability | −0.3 | −0.2 | −0.1 | 0.0 | −0.1 | 0.1 | −0.2 | −4.7 |
| 7 Days @ −30 °C | | | | | | | | |
| Dimensional Stability | −0.8 | −1.1 | −1.3 | −1.7 | −0.7 | −1.2 | −0.8 | −0.3 |
| 1 Day @ 70 °C | | | | | | | | |
| Dimensional Stability | −1.2 | 0.2 | −0.5 | −0.9 | 1.5 | 0.3 | −1.1 | 1.3 |
| 7 Days @ 70 °C | | | | | | | | |

| Material | 9 | 10 | 11 | 12 | 13 | 14 | 15 | 16 | 17 |
|---|---|---|---|---|---|---|---|---|---|
| Polyol 2 | — | — | — | — | — | 35.00 | 35.00 | 64.56 | 64.56 |
| Polyol 3 | 42.02 | 42.02 | 42.02 | — | — | — | — | — | — |
| Polyol 4 | 29.94 | 29.94 | 29.94 | — | — | — | — | — | — |
| Polyol 5 | — | — | — | — | — | — | — | 4.30 | 4.30 |
| Polyol 6 | — | — | — | 46.20 | 46.20 | — | — | — | — |
| Polyol 8 | — | — | — | — | — | 10.00 | 10.00 | 5.00 | 5.00 |
| Polyol 9 | — | — | — | — | — | 35.00 | 35.00 | — | — |
| Polyol 11 | — | — | — | — | — | — | — | 4.00 | 4.00 |
| Polyol 12 | — | — | — | 37.70 | 37.70 | — | — | — | — |
| Polyol 13 | 9.82 | 9.82 | 9.82 | — | — | — | — | — | — |
| Surfactant 2 | 2.45 | 2.45 | 2.45 | — | — | 2.00 | 2.00 | — | — |
| Surfactant 3 | — | — | — | 2.00 | 2.00 | — | — | — | — |
| Surfactant 4 | — | — | — | — | — | — | — | 2.00 | 2.00 |
| Catalyst 1 | 0.33 | 0.33 | 0.33 | 0.30 | 0.30 | — | — | — | — |
| Catalyst 3 | 0.78 | 0.78 | 0.78 | 1.10 | 1.10 | — | — | — | — |
| Catalyst 4 | 0.39 | 0.39 | 0.39 | — | — | — | — | — | — |
| Catalyst 5 | — | — | — | 0.20 | 0.20 | — | — | — | — |
| Catalyst 6 | — | — | — | — | — | 3.00 | 3.00 | 1.90 | 1.90 |
| Catalyst 7 | — | — | — | — | — | — | — | 0.25 | 0.25 |
| Catalyst 8 | — | — | — | — | — | — | — | 0.70 | 0.70 |
| Catalyst 9 | — | — | — | — | — | 1.50 | 1.50 | — | — |
| Additive 1 | — | — | — | 8.35 | 8.35 | — | — | — | — |
| Water | 1.82 | 1.82 | 1.82 | 4.15 | 4.15 | 3.60 | 3.60 | 1.90 | 1.90 |
| Blowing Agent 1 | 12.45 | 12.45 | 12.45 | — | — | — | — | — | — |
| Blowing Agent 2 | — | — | — | — | — | 9.50 | 9.50 | 15.39 | 15.39 |
| Isocyanate No. | 2 | 3 | 4 | 1 | 3 | 1 | 3 | 1 | 3 |
| Index | 1.13 | 1.01 | 1.00 | 1.11 | 1.00 | 1.10 | 1.00 | 1.08 | 1.00 |
| Ratio | 1.23 | 1.27 | 1.28 | 1.50 | 1.57 | 1.58 | 1.67 | 1.10 | 1.18 |
| Cream (s) | 7 | 8 | 8 | 9 | 10 | 18 | 17 | 27 | 28 |
| Gel (s) | 37 | 45 | 42 | 45 | 53 | 91 | 110 | 187 | 211 |
| Tack-Free (s) | 76 | 111 | 93 | 118 | 300 | 280 | 259 | 488 | 644 |
| Free-Rise Density (pcf) | 1.55 | 1.58 | 1.51 | 1.89 | 1.96 | 1.60 | 1.61 | 1.67 | 1.74 |
| Min. Fill Density (pcf) | 1.81 | 1.83 | 1.70 | 1.98 | 2.07 | 1.75 | 1.80 | 1.88 | 1.96 |
| Packed Density (pcf) | 1.97 | 2.04 | 1.84 | 2.18 | 2.25 | 1.95 | 1.96 | 2.09 | 2.18 |
| Packed/Core Ratio | 1.13 | 1.12 | 1.11 | 1.06 | 1.08 | 1.09 | 1.10 | 1.11 | 1.11 |
| k-Factor ((BTU · in)/(h · ft² · °F)) @ 35 °F | 0.133 | 0.134 | 0.130 | 0.150 | 0.152 | 0.143 | 0.133 | 0.135 | 0.128 |
| k-Factor ((BTU · in)/(h · ft² · °F)) @ 75 °F | 0.145 | 0.146 | 0.142 | 0.169 | 0.172 | 0.164 | 0.152 | 0.156 | 0.147 |
| Closed Cell Content (%) | 85.5 | 88.1 | 82.9 | 85.2 | 87.3 | 85.8 | 88.1 | 84.9 | 86.7 |
| Core Density (pcf) | 1.75 | 1.82 | 1.66 | 2.06 | 2.09 | 1.79 | 1.78 | 1.89 | 1.97 |
| Compressive Strength + (psi) | 15.5 | 15.4 | 9.4 | — | 22.6 | 18.3 | 13.4 | 17.4 | 17.4 |
| Compressive Strength = (psi) | 33.5 | 32.4 | 24.4 | — | 43.1 | 32.0 | 26.2 | 26.9 | 26.6 |
| Dimensional Stability | 0.2 | 0.2 | −2.4 | — | 0.0 | 0.3 | −0.1 | −0.3 | |
| 1 Day @ −30 °C | | | | | | | | | |
| Dimensional Stability | −0.2 | −0.2 | −6.2 | — | −0.5 | 0.2 | −2.0 | | |
| 7 Days @ −30 °C | | | | | | | | | |
| Dimensional Stability | 0.2 | −0.6 | 1.9 | — | −1.9 | −1.4 | −5.2 | −1.5 | |
| 1 Day @ 70 °C | | | | | | | | | |
| Dimensional Stability | 0.7 | −0.2 | 5.9 | — | −3.5 | −1.3 | −7.1 | | |
| 7 Days @ 70 °C | | | | | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1-129. (canceled)

130. A polyurethane foam-forming composition comprising:
(a) a polyol blend that has a weighted average functionality of 3 to 6 and a weighted average hydroxyl number of 300 to 500 mg KOH/g;
(b) a blowing agent composition comprising:
(1) a physical blowing agent, and
(2) a carbon dioxide-generating chemical blowing agent,
wherein the physical blowing agent comprises a halogenated olefin that is present (i) in an amount of 1% to 30% by weight, based on total weight of the polyurethane foam-forming composition except for the weight of the polyisocyanate, and (ii) in an amount of at least 80% by weight, based on total weight of physical blowing agent in the blowing agent composition, wherein the physical blowing agent composition and the carbon dioxide generating chemical blowing agent are present in a relative ratio, by weight, of at least 5:1; and
(c) a polyisocyanate comprising a urethane-modified polyisocyanate having a NCO group content of 25 to 35% by weight, based on the total weight of the urethane-modified polyisocyanate, and comprising a reaction product of components comprising:
(1) a polymethylene polyphenyl polyisocyanate (pMDI); and
(2) a monol,
wherein the polyisocyanate is present in an amount sufficient to provide an isocyanate index of 0.90 to 1.50.

131. The polyurethane foam-forming composition of claim 130, wherein the pMDI comprises:
i) up to 60% by weight of a first polymethylene polyphenyl polyisocyanate having a general formula (I), based on 100% by weight of the polymethylene polyphenyl polyisocyanate, 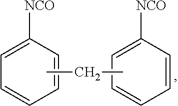
and
ii) at least 40% by weight of a second polymethylene polyphenyl polyisocyanate having a general formula (II), based on 100% by weight of the polymethylene polyphenyl polyisocyanate, 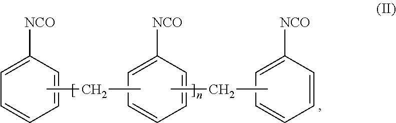
in which n is an integer having a value or 1 or more.

132. The polyurethane-foam forming composition of claim 130, wherein the monol is represented by the structure: 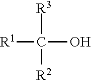
in which R¹, R², and R³ each independently represent H, a C₁-C₅₆ alkyl group, a C₆-C₅₆ aryl group, a C₃-C₅₆ cycloalkyl group, or a C₇-C₅₆ aralkyl group, or the groups R¹, R², and/or R³ may be linked via a ring system.

133. The polyurethane foam-forming composition of claim 132, wherein the monol comprises a C₁₂ primary alcohol, a C₁₃ primary alcohol, a C₁₄ primary alcohol, and a C₁₅ primary alcohol.

134. The polyurethane foam-forming composition of claim 130, wherein the monol comprises one or more isocyanate-reactive compounds containing an average isocyanate-reactive group functionality of 0.8 to 1.2.

135. The polyurethane foam-forming composition of claim 130, wherein the pMDI and the monol are reacted together in relative amounts such that 5 to 5000 NCO equivalents are present for each OH equivalent that is present.

136. The polyurethane foam-forming composition of claim 130, wherein the polyol blend comprises an amine-initiated polyether polyol that is a reaction product of an H-functional starter comprising an amine and an alkylene oxide.

137. The polyurethane foam-forming composition of claim 136, wherein the amine comprises an aromatic amine present in an amount of more than 50% by weight, based on the total weight of H-functional starter used to produce the amine-initiated polyether polyol, and the alkylene oxide comprises propylene oxide in an amount of at least 80% by weight, based on the total weight of alkylene oxide used to prepare the amine-initiated polyether polyol.

138. The polyurethane foam-forming composition of claim 137, wherein the amine-initiated polyether polyol has an OH number of 200 to 600 mg KOH/g and an average functionality of 3.5 to 4.5.

139. The polyurethane foam-forming composition of claim 138, wherein the amine-initiated polyether polyol is present in an amount of 30 to 80% by weight, based on the total weight of the polyol blend.

140. The polyurethane foam-forming composition of claim 130, wherein the polyol blend comprises a saccharide-initiated polyether polyol that is the reaction product of an H-functional starter comprising saccharide and an alkylene oxide.

141. The polyurethane foam-forming composition of claim 140, wherein saccharide is present in an amount of more than 50% by weight, based on the total weight of H-functional starter used to produce the saccharide-initiated polyether polyol, and propylene oxide is present in an amount of more than 50% by weight, based on the total weight of alkylene oxide used to prepare the saccharide-initiated polyether polyol.

142. The polyurethane foam-forming composition of claim 141, wherein the saccharide-initiated polyether polyol has an OH number of 200 to 600 mg KOH/g and a functionality of 4 to 6.

143. The polyurethane foam-forming composition of claim 142, wherein the saccharide-initiated polyether polyol is present in an amount of 30 to 60% by weight, based on the total weight of the polyol blend.

144. The polyurethane foam-forming composition of claim 130, wherein the polyol blend comprise an alkanolamine-initiated polyether polyol that is a reaction product of an alkylene oxide with an initiator comprising an alkanolamine, wherein the alkanolamine is present in an amount of more than 50% by weight, based on the total weight of initiator used to produce the alkanolamine-initiated polyether polyol.

145. The polyurethane foam-forming composition of claim 144, wherein propylene oxide is present in an amount of more than 50% by weight, based on the total weight of alkylene oxide used to prepare the alkanolamine-initiated polyether polyol.

146. The polyurethane foam-forming composition of claim 145, wherein the alkanolamine-initiated polyether polyol has an OH number of 500 to 900 mg KOH/g and a functionality of 2.5 to 3.5.

147. The polyurethane foam-forming composition of claim 130, wherein the halogenated olefin comprises 1-chloro-3,3,3-trifluoropropene present in an amount of 10 to 30% by weight, based on the total weight of the polyurethane foam-forming composition except for the weight of the polyisocyanate.

148. A polyurethane foam produced from the polyurethane foam-forming composition of claim 130, wherein the polyurethane foam has a closed-cell content of more than 80 percent, as measured according to ASTM D6226-15.

149. A method of producing a polyurethane foam, comprising reacting, at an isocyanate index of 0.90 to 1.50, a polyurethane foam-forming composition comprising:
(a) a polyol blend having a weighted average functionality of 3 to 6 and a weighted average hydroxyl number of 300 to 500 mg KOH/g;
(b) a blowing agent composition comprising:
(1) a physical blowing agent, and
(2) a carbon dioxide-generating chemical blowing agent,
wherein the physical blowing agent comprises a halogenated olefin that is present (i) in an amount of 1% to 30% by weight, based on total weight of the polyurethane foam-forming composition except for the weight of the polyisocyanate, and (ii) in an amount of at least 80% by weight, based on total weight of physical blowing agent in the blowing agent composition, and wherein the physical blowing agent composition and the carbon dioxide generating chemical blowing agent are present in a relative ratio, by weight, of at least 5:1; and
(c) a polyisocyanate comprising a urethane-modified polyisocyanate having a NCO group content of 25 to 35% by weight, based on the total weight of the urethane-modified polyisocyanate, and comprising a reaction product of components comprising:
(1) a polymethylene polyphenyl polyisocyanate; and
(2) a monol.
